(19) United States
(12) Patent Application Publication
(10) Pub. No.: US 2009/0052793 A1
(43) Pub. Date: Feb. 26, 2009

(54) DIGITAL CONTENT PROCESSING METHODS AND SYSTEMS

(75) Inventors: Chun-Hsiang Huang, Taipei City (TW); Shang-Chih Chuang, Taipei City (TW); Ja-Ling Wu, Taipei City (TW)

Correspondence Address: QUINTERO LAW OFFICE, PC, 2210 MAIN STREET, SUITE 200, SANTA MONICA, CA, 90405, US

(73) Assignee: NATIONAL TAIWAN UNIVERSITY, TAIPEI (TW)

(21) Appl. No.: 12/142,721

(22) Filed: Jun. 19, 2008

(30) Foreign Application Priority Data
Aug. 24, 2007 (TW) TW96131461

(51) Int. Cl. G06K 9/54

(52) U.S. Cl. 382/254

(57) ABSTRACT

Digital content processing methods and systems are provided. First, an image property and a specific value corresponding to the image property are determined according to an image enhancement operation. Then, a specific region is sought within a first digital content, wherein pixels in the specific region have the specific value corresponding to the image property. Specific information is embedded in the specific region of the first digital content to generate a second digital content having the specific information. A digital content playback device performs the image enhancement operation on the second digital content to obtain the specific information.

### CROSS REFERENCE TO RELATED APPLICATIONS

This Application claims priority of Taiwan Patent Application No. 096131461, filed on Aug. 24, 2007, the entirety of which is incorporated by reference herein.

### BACKGROUND OF THE INVENTION

1. Field of the Invention

The disclosure relates generally to digital content processing methods and systems, and, more particularly to methods and systems that embed specific information in a digital content using an unseen visible watermarking (UVW) technology.

2. Description of the Related Art

Generally, specific information such as copyright information and/or annotation data can be embedded in a digital content such as a digital image using invisible watermarking or visible watermarking schemes.

In invisible watermarking, the fidelity of digital content embedded with specific information is always guaranteed. However, modules or equipments for extracting specific information must be deployed. The extraction modules or equipments usually require additional deployment costs, thereby limiting the use of watermarking applications.

In visible watermarking, visible patterns are embedded in a digital content. Though the embedded patterns are claimed to be unobtrusive, content viewers are annoyed at degraded visual quality. Consequently, applications of visible watermarking are often limited to content browsing or previewing.

### BRIEF SUMMARY OF THE INVENTION

Digital content processing methods and systems are provided.

In an embodiment of a digital content processing method, an image property and a specific value corresponding to the image property are determined according to an image enhancement operation. Then, a specific region is sought within a first digital content, wherein pixels in the specific region have the specific value corresponding to the image property. Specific information is embedded in the specific region of the digital content to generate a second digital content having the specific information.

In another embodiment of a digital content processing method, a digital content is obtained. Then, an image enhancement operation is performed on the digital content to obtain specific information.

An embodiment of a digital content processing system comprises a storage unit, a digital content reception unit, and a processing unit. The storage unit comprises specific information. The digital content reception unit receives a digital content. The processing unit determines an image property and a specific value corresponding to the image property according to an image enhancement operation. The processing unit seeks a specific region within a first digital content, wherein pixels in the specific region have the specific value corresponding to the image property. The processing unit embeds the specific information in the specific region of the digital content to generate a second digital content having the specific information.

Another embodiment of a digital content processing system comprises a digital content playback device. The digital content playback device obtains a digital content, and performs an image enhancement operation on the digital content to obtain specific information.

Digital content processing methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a digital content processing system according to the invention;

FIG. 2 is a schematic diagram illustrating another embodiment of a digital content processing system according to the invention;

FIG. 3 is a flowchart of an embodiment of a digital content processing method according to the invention;

FIG. 4 is a flowchart of another embodiment of a digital content processing method according to the invention; and

FIG. 5 is a schematic diagram illustrating the relationship between input and output intensities for gamma correction.

### DETAILED DESCRIPTION OF THE INVENTION

Digital content processing methods and systems are provided.

In the application, users cannot view specific information embedded in a digital content before an image enhancement operation. However, users can directly view the specific information on the digital content after the digital content is performed with the image enhancement operation. That is, an unseen visible watermarking (UVW) technology is provided in the application. It is understood that the digital content may be a digital image, video, and/or digital document. The digital image is used as examples in the following embodiments.

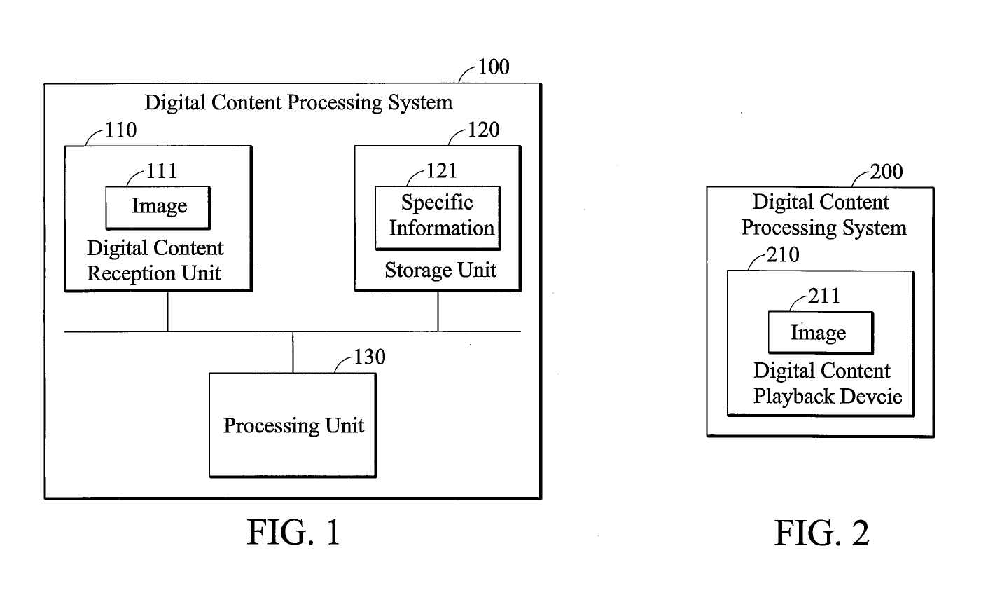

FIG. 1 is a schematic diagram illustrating an embodiment of a digital content processing system according to the invention. In this embodiment, the digital content processing system embeds specific information in an image.

The digital content processing system 100 comprises a digital content reception unit 110, a storage unit 120, and a processing unit 130. The digital content reception unit 110 receives at least one image 111. It is noted that the image 111 may be a single image or a specific frame of a video. The storage unit 120 comprises specific information 121. The specific information 121 may be copyright information and/or annotation data. It is understood that the specific information 121 may be distributed within an area of a specific range, and/or displayed as a specific pattern. The processing module 130 performs the digital content processing methods of the invention to embed the specific information 121 in the image 111 according to the property of an image enhancement operation. Related detail is discussed later.

FIG. 2 is a schematic diagram illustrating another embodiment of a digital content processing system according to the invention. In this embodiment, the digital content processing system obtains specific information from an image. The digital content processing system 200 comprises at least a digital content playback device 210, such as television, monitor, and others. The digital content playback device 210 receives an image 211, and obtains specific information from the image 211.

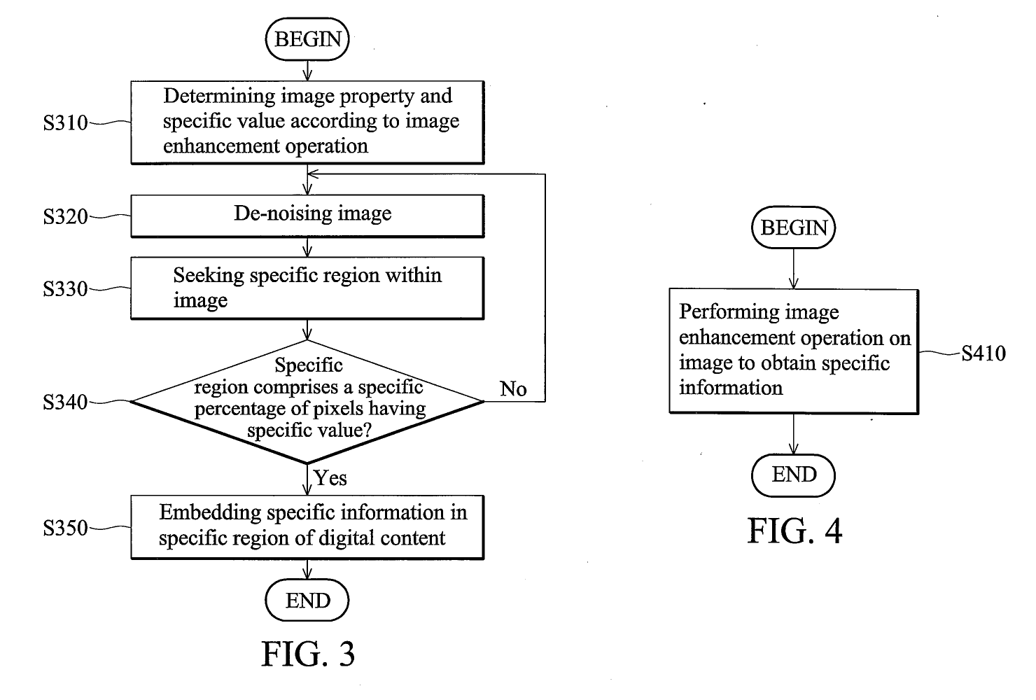

FIG. 3 is a flowchart of an embodiment of a digital content processing method according to the invention. This embodiment is suitable for use in the digital content processing system in FIG. 1.

In step S310, an image property and a specific value corresponding to the image property are determined according to an image enhancement operation. It is understood that the image enhancement operation may comprise gamma correction, histogram equalization, contrast stretching, and others. Since the image enhancement operation has an adjustment equation to adjust at least one image property, such as intensity, hue, contrast, and saturation of an image, a specific image property can be determined according to the image enhancement operation. Additionally, since the image enhancement operation adjusts input values and generates output values according to the adjustment equation, in some embodiments, the input value is determined as the specific value if the difference between the input value and the corresponding output value adjusted by the image enhancement operation is at a maximum threshold.

In step S320, the image 111 is performed with a de-noising operation to remove the noises of the image 111. In some embodiments, an image property value close to the specific value can be set as the specific value. That is, for respective pixels in the image, if the image property value of the pixel falls within a predefined range of the specific value, the image property value of the pixel is set as the specific value. For example, if the specific value corresponding to the image property is 0, and the predefined range is 3, the image property value of respective pixel having the image property value 1, 2 or 3 is set to 0. It is understood that the predefined range can be adjusted according to different requirements.

In step S330, a specific region is sought within the image 111. It is understood that several candidate regions can be selected from the image, and the respective candidate region is greater than or equal to the region distributed by the specific information. The candidate region with most pixels having the specific value corresponding to the image property is selected as the specific region. In step S340, it is determined whether the percentage of pixels having the specific value corresponding to the image property in the specific region is greater than a specific percentage. If not (No in step S340), the procedure returns to step S320, and the predefined range is adjusted. For example, the predefined range is enlarged, and the image is further de-noised according to the adjusted predefined range. It is understood that since the enlarged predefined range may reduce the fidelity of the image, in some embodiments, the predefined range may have an upper threshold, and the de-noising operation is stopped if the predefined range is adjusted to the upper threshold. If so (Yes in step S340), in step S350, than the specific information is embedded in the specific region of the image to generate an image having the specific information. In some embodiments, the embedding of the specific information is to modify the image property values of pixels in the specific region according to the specific information, wherein the pixels are located at corresponding locations indicated by the specific information. For example, the image property value of a pixel at the position indicated by the specific information is set to the specific value plus a predetermined value.

FIG. 4 is a flowchart of another embodiment of a digital content processing method according to the invention. This embodiment is suitable for use in the digital content processing system in FIG. 2. In step S410, an image enhancement operation is performed on the image 211 to obtain specific information. It is understood that the image enhancement operation used in step S410 must be the image enhancement operation used to embed the specific information in the image.

An example in gamma correction follows.

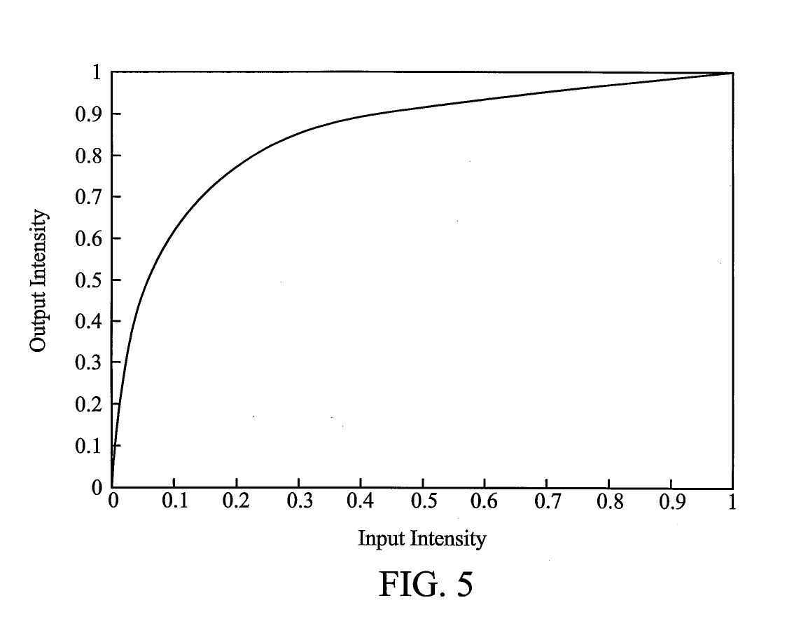

Gamma correction is used to improve the intensity insufficiency of monitors. That is, gamma correction adjusts the intensity property of an image. FIG. 5 is a schematic diagram illustrating the relationship between input and output intensities for gamma correction. The adjustment equation of gamma correction is s=cr^{γ}. If γ is greater than 1, the input intensity is adjusted to an enhanced output intensity according to the definition of the above equation. Generally, the value of γ usually varies between 1.8 and 2.5. It is understood that, in gamma correction, a narrow range of dark input value will be mapped to a wide range of output gray-level values. That is, a slight change in intensity which cannot be originally determined by the naked eye can be recognized after gamma correction. In the embodiment of gamma correction, the image property is determined as intensity, and the specific value can be determined as a value such as 0 in the narrow range. An image is de-noised by setting the image property value of respective pixels having the image property value 1, 2 or 3 to 0 if the predefined range is 3. After de-noising, the display effects of the embedded specific information will be improved accordingly.

Then, a specific region is sought within the image according to the predefined region (area size) distributed by the specific information. The candidate region with most pixels having intensity value 0 is selected as the specific region. Similarly, if the percentage of pixels having intensity value 0 in the specific region is not greater than a specific percentage, the image is further de-noised according to a new predefined range. For example, the image property value of respective pixels having the image property value 1, 2, 3, 4 or 5 is set to 0. After the de-noising operation, the specific region is re-sought within the image. Finally, the specific information is embedded in the specific region of the image to generate an image having the specific information. In an example, the specific information is a pattern comprising black and white pixels. In embedding of the specific information, the intensity value of the pixel located at locations corresponding to the black pixel in the specific information is kept as 0, and the intensity value of the pixel located at locations corresponding to the white pixel in the specific information is set as 3. It is noted that since the adjusted offset is slight, the fidelity of the image embedded with the specific information is guaranteed. If users want to obtain the specific information embedded in the image, a digital content playback device can be employed to perform gamma correction on the image. After gamma correction, the embedded specific information can be directly seen on the image.

It is noted that, in above embodiments, users can see the specific information on the image after the image is performed with the image enhancement operation. However, in some embodiments, users can directly see the specific information on the image if they proceed with a specific behavior. For example, different viewing angles related to LCD (liquid crystal display) monitors result in different contrast behaviors, the hidden specific information can be revealed by viewing the LCD monitors from certain viewing angles. Specifically, if users view a digital document on the LCD monitor at a normal angle, no specific information would be seen. However, if users change the viewing angle to the LCD monitor, the specific information could be seen on the digital document. Additionally, when users use a high resolution printer to print out the digital document, the specific information would be seen on the digital document.

In the application, the image enhancement technology is integrated into the data hiding technology. That is, the image enhancement operation is applied to the extraction procedure for specific information. Therefore, users can display the specific information contained in digital contents on screens using the image enhancement capability provided by general display devices. In other words, the application will not reduce the fidelity of digital content, and no deployment of specific extraction modules or equipments are needed.

Digital content processing methods and systems, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A digital content processing method, comprising:
determining an image property and a specific value corresponding to the image property according to an image enhancement operation;
seeking a specific region within a first digital content, wherein pixels in the specific region have the specific value corresponding to the image property; and
embedding specific information in the specific region of the first digital content to generate a second digital content having the specific information.

2. The method of claim 1, wherein the specific region comprises at least a specific percentage of pixels having the specific value corresponding to the image property.

3. The method of claim 1, wherein the specific information is distributed within a predefined region, and the specific region is greater than or equal to the predefined region.

4. The method of claim 1, further comprising de-noising the digital content by setting the image property values close to the specific value of pixels in the digital content as the specific value.

5. The method of claim 1, wherein the embedding of the specific information is to modify the image property values of pixels in the specific region according to the specific information, wherein the pixels are located at corresponding locations indicated by the specific information.

6. The method of claim 5, wherein the image property value of a specific pixel at a position indicated by the specific information is set to the specific value plus a predetermined value.

7. The method of claim 1, further comprising performing the image enhancement operation on the second digital content to obtain the specific information from the second digital content.

8. The method of claim 1, wherein the image property comprises intensity, hue, contrast, or saturation.

9. The method of claim 1, wherein the image enhancement operation comprises gamma correction, histogram equalization, or contrast stretching.

10. A digital content processing method, comprising:
obtaining a digital content; and
performing an image enhancement operation on the digital content to obtain the specific information from the digital content.

11. The method of claim 10, wherein the image enhancement operation adjusts an image property of the digital content.

12. The method of claim 11, wherein the image property comprises intensity, hue, contrast, or saturation.

13. The method of claim 10, wherein the image enhancement operation comprises gamma correction, histogram equalization, or contrast stretching.

14. A digital content processing system, comprising:
a storage unit, comprising specific information;
a digital content reception unit, receiving a first digital content; and
a processing unit, determining an image property and a specific value corresponding to the image property according to an image enhancement operation, seeking a specific region within the first digital content, wherein pixels in the specific region have the specific value corresponding to the image property, and embedding specific information in the specific region of the first digital content to generate a second digital content having the specific information.

15. The system of claim 14, wherein the specific region comprises at least a specific percentage of pixels having the specific value corresponding to the image property.

16. The system of claim 14, wherein the specific information is distributed within a predefined region, and the specific region is greater than or equal to the predefined region.

17. The system of claim 14, wherein the processing unit further de-noises the digital content by setting the image property values close to the specific value of pixels in the digital content as the specific value.

18. The system of claim 14, wherein the processing unit embeds the specific information to the first digital content by modifying the image property values of pixels in the specific region according to the specific information, wherein the pixels are located at corresponding locations indicated by the specific information.

19. The system of claim 18, wherein the processing unit sets the image property value of a specific pixel at a position indicated by the specific information to the specific value plus a predetermined value.

20. The system of claim 14, further comprising a digital content playback device to perform the image enhancement operation on the second digital content to obtain the specific information from the second digital content.

21. The system of claim 14, wherein the image property comprises intensity, hue, contrast, or saturation.

22. The system of claim 14, wherein the image enhancement operation comprises gamma correction, histogram equalization, or contrast stretching.

23. A digital content processing system, comprising:
a digital content playback device, obtaining a digital content, and performing an image enhancement operation on the digital content to obtain the specific information from the digital content.

24. The system of claim 23, wherein the image enhancement operation adjusts an image property of the digital content.

25. The system of claim 23, wherein the image property comprises intensity, hue, contrast, or saturation.

26. The system of claim 23, wherein the image enhancement operation comprises gamma correction, histogram equalization, or contrast stretching.

27. A machine-readable storage medium comprising a computer program, which, when executed, causes a device to perform a digital content processing method, and the method comprising:
determining an image property and a specific value corresponding to the image property according to an image enhancement operation;
seeking a specific region within a first digital content, wherein pixels in the specific region have the specific value corresponding to the image property; and
embedding specific information in the specific region of the first digital content to generate a second digital content having the specific information.

28. A machine-readable storage medium comprising a computer program, which, when executed, causes a device to perform a digital content processing method, and the method comprising:
obtaining a digital content; and
performing an image enhancement operation on the digital content to obtain the specific information from the digital content
